(19) United States
(12) Patent Application Publication
(10) Pub. No.: US 2008/0040273 A1
(43) Pub. Date: Feb. 14, 2008

(54) Digital data interchange devices and networks

(76) Inventors: John G. Savage, Fife (GB); Scott P. MacKenzie, Dundee (GB); Kenneth A. Nicoll, Dundee (GB)

Correspondence Address: MICHAEL CHAN;NCR CORPORATION, 1700 SOUTH PATTERSON BLVD, DAYTON, OH, 45479-0001, US

(21) Appl. No.: 11/973,567

(22) Filed: Oct. 9, 2007

Related U.S. Application Data
(63) Continuation of application No. 09/433,139, filed on Nov. 3, 1999, now abandoned.

(30) Foreign Application Priority Data
Nov. 11, 1998 (GB) 9824764.6
Sep. 24, 1999 (GB) 9922538.5

(51) Int. Cl. G06Q 40/00

(52) U.S. Cl. 705/43

(57) ABSTRACT

A self-service terminal (12) forming part of a SST network is provided with an infra-red port (30) enabling digital data interchange to take place between the SST (12) and a portable electronic digital device (20 or 90) having a corresponding matching port (82 or 92) which is presented to the SST (12). The portable device (20 or 90) may be any device having an electronic digital data memory. Examples include PDAs (20), digital cameras (90) and cellular mobile phones. The SST network is connected to the Internet thus enabling data interchange to take place between the portable device (20 or 90) and any Internet address. Thus the SST (12) can be used to interchange data between a customer's PDA (20) and his home computer (16).

This application is a continuation application of co-pending application Ser. No. 09/433,139 filed Nov. 3, 1999.

### BACKGROUND OF THE INVENTION

This invention relates to digital data interchange devices and has particular application in self-service terminals (SSTs) and networks.

Self-service terminals are public access terminals that provide services to the users of the terminals.

One type of SST is an automated teller machine (ATM). ATMs dispense cash from a safe to valid users. ATMs are typically owned by a financial institution (such as a bank) and are connected by a digital data network. The digital data network is also owned by the financial institution and has reliable and secure communication links between each ATM in the network, and has a central host device and server.

Other types of SSTs do not dispense cash, but deliver tickets, vouchers, or information to a user, sometimes in return for payment by use of a magnetic stripe card or a smart card. Such SSTs may also be linked by a digital data network.

Most SSTs dispense some form of paper-based media. For example, ATMs typically dispense cash, receipts, and statements; non-cash SSTs typically dispense tickets, vouchers, and such like. For this reason, most SSTs include a printer, printer paper storage, paper feed devices, and such like. Having a printer installed in an SST means that the printer has to be serviced regularly, and the consumables (such as paper, ink, ribbon, cartridge, or such like) have to be replenished periodically. The paper-based media is also liable to be lost or discarded unwittingly by the recipient because it is flimsy. Furthermore, because of the limited capabilities of the printers in terms of resolution and graphics, the paper-based records produced tend to be crude and easily copied.

Recently, various kinds of portable digital devices, known as Personal Digital Assistants (PDAs) have become widely used. Examples of PDAs include the Psion Series 5 (trade mark) and the 3Com Palmpilot (trade mark). Other portable digital devices, for example laptop computers, digital cameras, and mobile cellular telephones are also widely used.

### SUMMARY OF THE INVENTION

The invention generally relates to a self-service terminal that is adapted to communicate information to a customer in electronic rather than paper-based form.

The invention also generally relates to a self-service terminal having a port for communicating with a customer's portable digital device.

According to a first aspect of the invention there is provided a self service terminal including a digital data port, and digital data transfer means for transferring data between the port and a digital data network; wherein the digital data port is adapted for the interchange of digital data between the terminal and a portable digital device having a corresponding matching port and presented by a customer.

By virtue of this aspect of the invention, information may be transmitted from the SST to a customer's portable digital device, without the need to print out the information onto a paper-based receipt, ticket, voucher, or such like. This enables a customer to obtain statements, transaction information, tickets, vouchers, and such like, in electronic form directly from an SST, and to store this information on the customer's device. The customer may view the information at a later time on the device. Alternatively or additionally, the customer may upload the information to another device (such as a personal computer). The customer may use another device (for example, a PC) to store and or track the information using personal banking software. The information may be printed out at a later time using a printer owned by the customer.

The port may be a wireless port and may be adapted to receive data and transmit data on a wireless carrier signal, such as an infra red signal. Alternatively, but much less preferred, the port may have an externally accessible physical connector.

According to a second aspect of the invention there is provided a self-service terminal network comprising a plurality of SSTs as described above, a digital server, and communication links between the SSTs and the server.

By providing a network of SSTs, information may be transferred from one SST to another SST.

The communication links may be dedicated links so as to enhance the reliability and security of the data interchange operation. To enhance the universality of the network, further communication links may be provided for transferring data between the network and an external network. In addition means may be provided for connecting the network to the Internet or to a non-Internet database.

By providing links for connecting the network to another network or to a database, information may be transferred from one location on one network to another location on another network, for example via email, to enable access to the information. In this way, media may be sent directly from the SST to a customer's own email address for uploading to a personal computer for reference and/or further processing. Alternatively, the SST may be used as a terminal for sending media from a portable digital device to, for example, an email address. Thus, images from a digital camera might be sent from an SST to another location, such as a user's own email address, to free up memory in the device and so enable additional images to be recorded. The images sent to the email address may then be uploaded to a personal computer for storing, viewing and/or further processing.

According to a third aspect of the invention there is provided a self-service terminal network comprising a server connected to a network of self-service terminals, each terminal having an email facility for sending information to a user by email.

The information may be transaction information such as a receipt or a bank statement.

According to a fourth aspect of the invention there is provided a self-service terminal having an email facility.

Preferably, the SST includes a digital data port for interacting with a portable digital device retained by a customer, so that the SST is operable to read personal information from the customer's portable digital device.

The personal information may include email addresses, calendar entries, contacts lists, previous purchases, and such like.

Preferably, the SST is operable to build a customer profile based on the personal information stored in the customer's portable digital device.

In one embodiment, the SST may operate as a server from which a customer may download email messages and to which a customer may send email messages.

According to a fifth aspect of the invention there is provided a method of building a profile of a customer, the method comprising the steps of: using a self-service terminal to receive information from the portable digital device retained by a customer, analysing the received information, and storing the analysed information in a database entry for that customer.

Many PDAs and digital cameras are already provided with infra-red communication ports or can have them incorporated without difficulty, as can other portable electronic digital devices such as cellular mobile phones.

With the increased use of PDAs as well as other portable electronic digital devices which incorporate digital data memory there is an increasing requirement to download and upload digital data to and from such devices.

SST networks exist throughout the world and many of them are interlinked with each other. Thus such networks, with their reliable and secure communication links, provide an opportunity to send and retrieve digital data to and from any location where there is an SST.

### BRIEF DESCRIPTION OF THE DRAWINGS

These and other aspects of the invention will be apparent from the following specific description, given by way of example, with reference to the accompanying drawings, in which:

FIG. 1 is a block diagram of an SST network embodying the invention;

FIG. 2 is a pictorial view of one of the SSTs shown in FIG. 1;

FIG. 3 is a simplified block diagram of the SST of FIG. 2;

FIG. 4 is a pictorial view of the other SST shown in FIG. 1;

FIG. 5 is a simplified block diagram of the SST of FIG. 4;

FIG. 6 is a simplified block diagram of a portable digital device for use with the network of FIG. 1; and

FIG. 7 is a simplified block diagram of the device of FIG. 6 communicating with the SST of FIG. 2.

### DETAILED DESCRIPTION

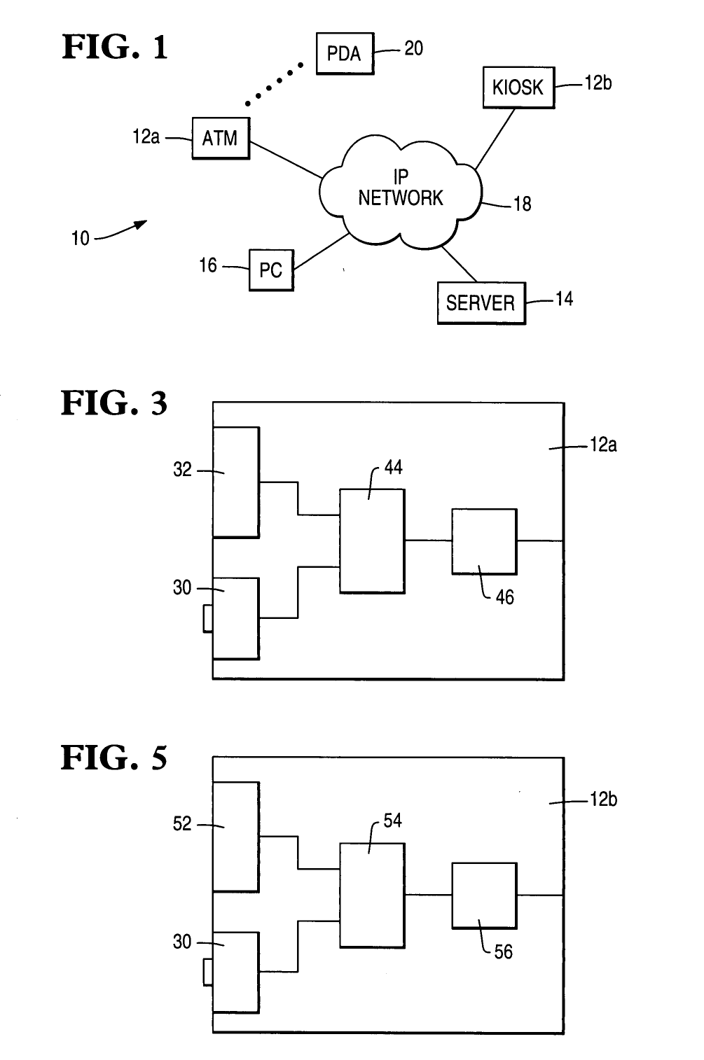

Referring now to FIG. 1 there is shown therein an SST network system 10. System 10 comprises a plurality of SSTs 12 (two are shown for illustrative purposes), a server 14 in the form of a host device, and a personal computer (PC) 16, all of which are interconnected by reliable and secure communication links 18 in the form of an IP (internet protocol) network, such as the Internet.

It will be appreciated that the system 10 may include a plurality of PCs 16, and other devices adapted for connection to an IP network 18.

The SSTs 12 include an ATM 12a and a non-cash kiosk 12b.

A portable digital device 20 in the form of a PDA is also shown in FIG. 1. The PDA 20 is shown connected to one of the SSTs (ATM 12a) in system 10 by a broken line, to illustrate that the PDA 20 can communicate with system 10 but there is no physical connection between the ATM 12a and the PDA 20.

Referring to FIGS. 2 and 3, ATM 12a has a digital data port 30 in the form of an IrDA-compliant (Infra-red Data Association) port. ATM 12a also has a conventional user interface 32 comprising an encrypting keypad 34, a display 36, a receipt delivery slot 38, a cash dispense slot 40, and a card receiving slot 42. The receipt delivery slot 38, the cash dispense slot 40, and the card receiving slot 42 are aligned with a printer module (not shown), a cash dispense module (not shown), and a card reader module (not shown), respectively. The nature and operation of these modules are well known and will not be described in detail herein.

The ATM 12a also has a controller 44 for controlling the operation of the ATM 12a and for sending information to and receiving information from the IP network 18 via a network connection 46. The controller 44 and the network connection 46 together form digital data transfer means.

In use, when a customer inserts his card into card slot 42, enters his PIN into keypad 34, and selects a transaction, the controller 44 sends a transaction authorisation request over network 18 from the ATM 12a. The ATM 12a awaits receipt of validation of the authorisation request from the host 14 before dispensing cash from dispense slot 40.

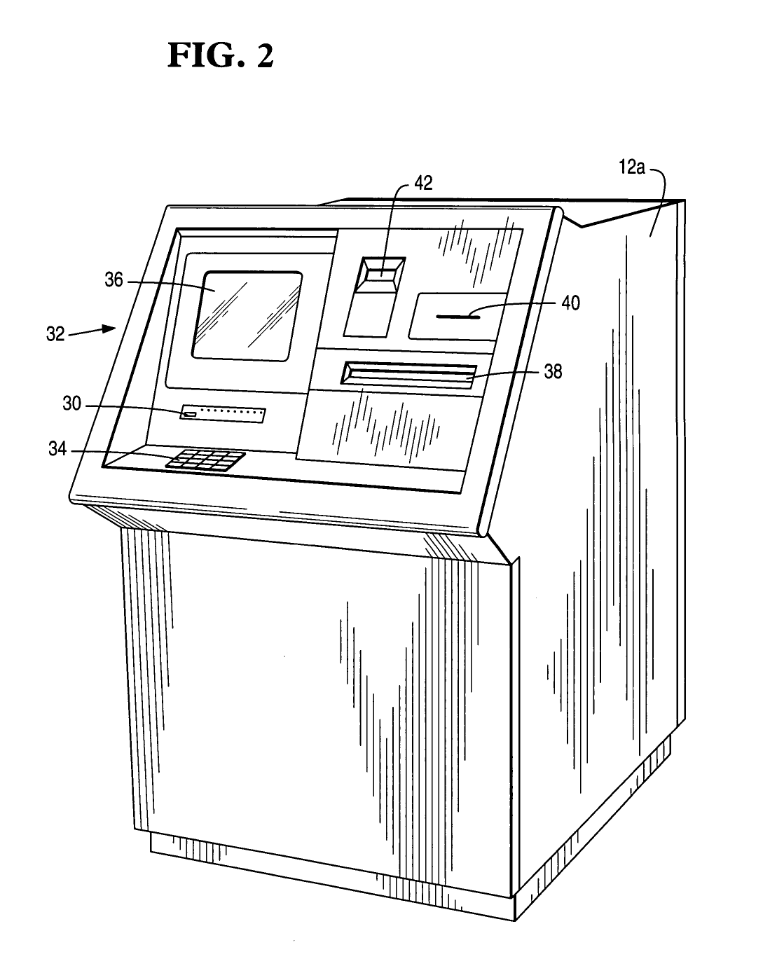

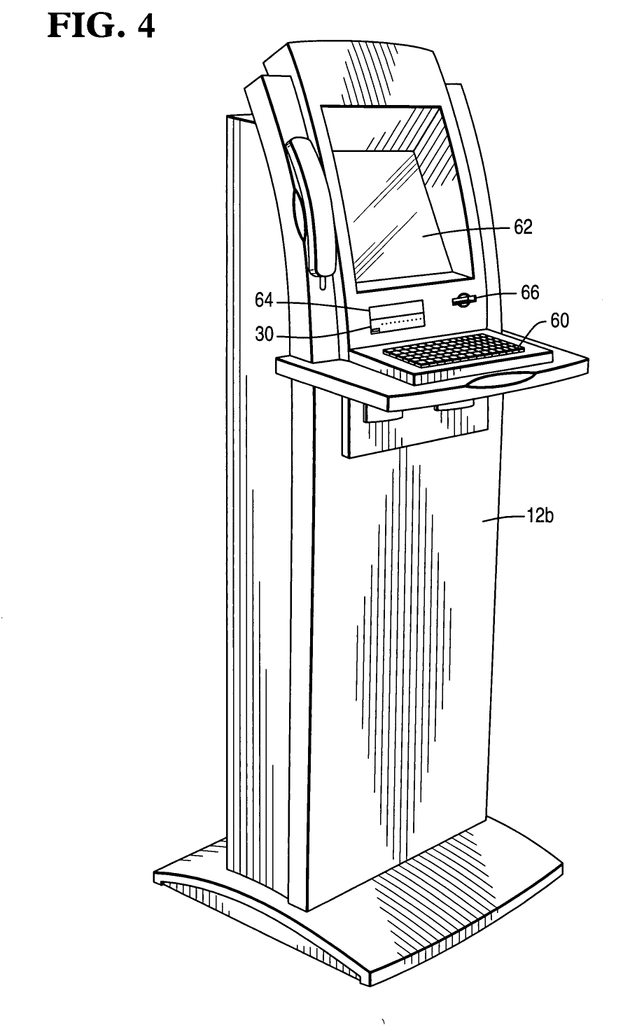

Referring to FIGS. 4 and 5, kiosk 12b also has a digital data port 30 in the form of an IrDA-compliant (Infra-red data association) port, a user interface 52, a controller 54, and a network connection 56. The user interface 52 comprises: a keyboard 60, a display 62, a receipt delivery slot 64, and a card receiving slot 66.

Referring now to FIGS. 2 to 5, the ATM 12a and the kiosk 12b both have a digital data port 30 located in the vicinity of the displays 36,62; each port having an identifier, in the form of text, to facilitate location of the port 30 by a customer. The text highlights the location and purpose of the ports 30, and may include instructions to assist a customer in using the ports 30.

The ports 30 include an IR to electrical signal converter so that the ports 30 can convey electrical signals to and receive electrical signals from the respective controllers 44 or 54. This enables the exchange of information between each port 30 and its associated controller 44 or 54.

Port 30 enables digital data to be interchanged between a portable electronic digital device such as a PDA 20 (FIG. 1) or digital camera.

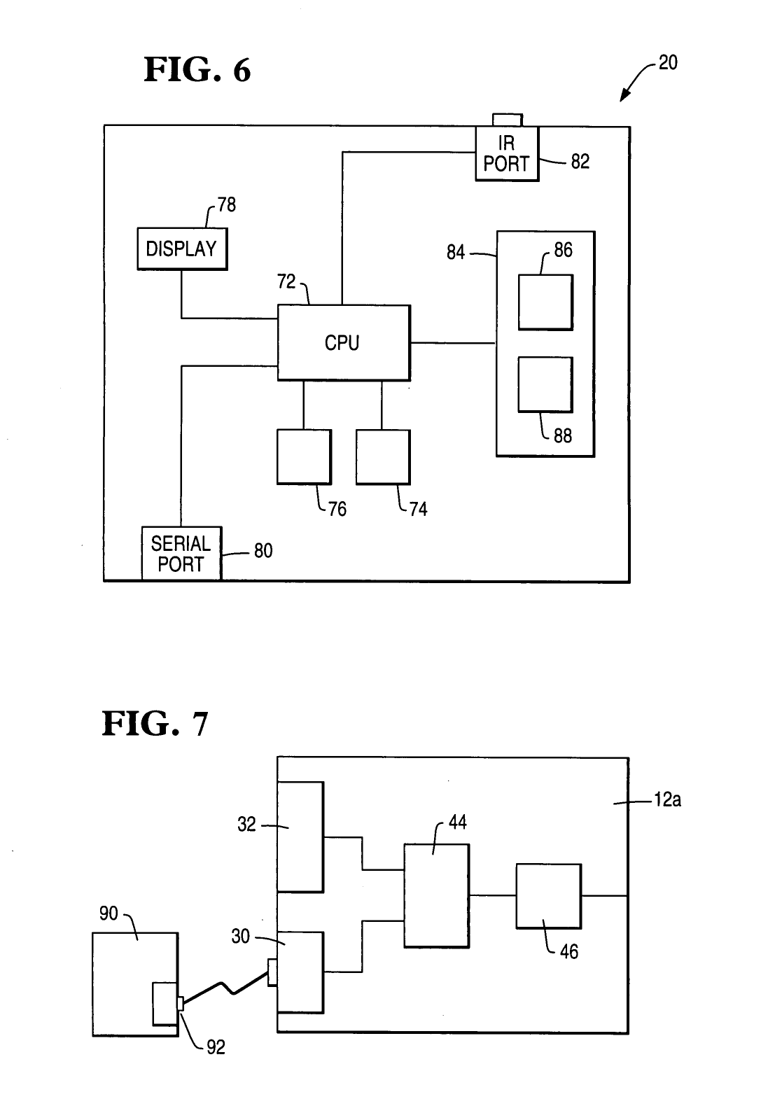

Referring to FIG. 6, PDA 20 comprises a controller 72 and associated volatile memory 74 and non-volatile memory 76, a touch-sensitive display 78, a serial communication port 80 for receiving a connector, a communication port 82 in the form of an IrDA (Infra-red data association) compliant infra-red port, and a terminal interface 84.

The PDA 20 is a standard 3Com (trade mark) PalmIII (trade mark) PDA having a software module (the terminal interface 84) downloaded to it. Controller 72 is responsible for the operation of the PDA 20, and is coupled to the display 78, serial port 80, IR port 82, and terminal interface 84.

Terminal interface 84 includes a user interface element 86 and an encryption/decryption facility 88 in the form of a cryptographic module. The user interface element is used to transfer data to and from an SST 12, and the encryption/decryption facility is a standard module used to encrypt the transferred data.

Communication port 82 is suitable for communicating with port 30. To effect communication, the PDA 20 is moved to within operating distance of the port 30 and oriented so that the matching ports 30,82 are aligned.

As the ATM 12a and the kiosk 12b of FIG. 1 are coupled to the Internet, interchange of digital data can take place world-wide between any digital device coupled to port 30 and any Internet site or WWW address.

Some possible uses for such a facility will now be described.

Referring to FIG. 7, a customer is at a remote location, for example at a holiday resort or at a business conference. He has a digital camera 90 having an IrDA-compliant port 92, and wishes to upload digital images stored therein, perhaps because the memory is full or nearly full. He takes camera 90 to the nearest ATM 12a having a suitable port 30 and initiates a data transfer session to the ATM 12a. The ATM 12a requests the customer to point the infra-red data transfer port 92 at the port 30. The ATM 12a establishes connection with the camera 90, uploads the desired images and sends the uploaded images to the server 14 (FIG. 1).

The transferred data can then be downloaded from server 14 through the Internet to another server, as specified by the customer via the input device (keypad 34), and thence to his home PC 16 (FIG. 1). Camera 90 now has free memory space and is available to take more pictures. A similar transfer can be initiated from a customer's PDA 20 or mobile phone.

Alternatively, or in addition to uploading data from PDA 20, it is possible to use port 30 to download information to PDA 20. PDA 20 is prior loaded with a customer's requests for digital information. Such requests can be, for example, for the customer's e-mail or voice mail messages, or for information relating to accommodation, entertainment or dining at a specific location. PDA 20 is then taken to a nearby ATM 12a or kiosk 12b and a digital interchange session is initiated between the customer's PDA 20 and ATM 12a or kiosk 12b. The requests are uploaded and transferred to a predetermined Internet address and the sought for information is then downloaded through the Internet and the SST network to kiosk 12b and thence through port 30 to the customer's PDA 20.

Information originating within a banking network, for example financial information either of a general nature (e.g. stockmarket information) or of a personal nature (e.g. the customer's bank balance), can also be downloaded to the customer's PDA 20 in this manner. Alternatively, this information can be sent to the customer's email address. For example, the customer may complete a normal ATM transaction to obtain cash up to the point in the transaction where receipt information has been prepared by the ATM 12a. The ATM 12a may then request the customer to point the infra-red port 82 of his PDA 20 at the infra-red port 30 of the ATM 12a. The ATM 12a receives the wireless transmission from the PDA 20, establishes a connection with the PDA 20, and downloads the transaction information to the PDA 20. If the ATM 12a cannot establish a connection with the PDA port 82 then the customer is prompted to re-align the PDA 20 with the port 30. On successful download, the information can be held and reconciled locally on the PDA 20, or transferred to another device having a digital data interchange facility (for example a home PC) for storage and reconciliation. In this way, transaction information and statements may be downloaded from ATM 12a directly into a PDA 20 in electronic form without the need to print a paper-based record or receipt.

If a customer requests the ATM 12a to send a receipt to the customer's email address then the ATM 12a may invite the customer to enter the email address or the ATM 12a may access a database storing the customer's email address. The customer may permit the ATM 12a to read some of the contents of the PDA 20 for use in updating the ATMs database for that customer. The ATM 12a may read the calendar entries for the customer, a list of recent purchases, or other information. The ATM 12a may use the calendar information to supply the customer with information appropriate to the customer's whereabouts. For example, if the customer intends visiting a foreign country on a certain date, and has entered this information into the calendar, the ATM 12a may read this information and offer the customer specific information relating to the foreign country for that date. This specific information may include details of festivals or other events that are scheduled for that date in the foreign country.

Instead of, or in addition to, infra-red port 30, a port operating with a wireless carrier on another waveband, or else a plug-in port with an externally accessible physical connector, can equally well be used. However, a port providing a wireless connection is preferred because of ease of use by a customer.

Where the nature of the information to be transferred between a PDA and SST is sensitive or valuable to the customer, it may be desirable to ensure that this information is encrypted or secured in some fashion, for example, using the encryption/decryption facility 88. This protects the information from malicious or accidental access by third parties while it is being transmitted.

Existing techniques that are applied to physical communication links could be applied equally well to communications between a PDA and an SST, as described herein. Equally, it would be possible to introduce a unique security technique appropriate for PDA transmission. Either of these approaches would provide the data with a level of security at least as secure as that of existing physical security systems.

While the above description has been in connection with use by a customer, the invention is also applicable to use by service personnel and field engineers of the SST network who can upload diagnostic data through port 30 or else through a similar second port to which access is limited to authorised personnel. Such a second port may be located within the SST 12 so that only authorised personnel have access to that port.

The communication links 18 may be dedicated links so that the SSTs are linked directly to the server 14.

The ATM 12a or kiosk 12b may be connected to the Internet either through server 14, or in any other way. The IP network 18 may be an Intranet, Extranet, or such like, so that only certain users or certain PCs can access the network 18.

What is claimed is:

1. An automated teller machine (ATM) comprising:
a first communication port for enabling wireless communication between the ATM and a first portable device retained by an ATM customer when the ATM customer uses the first portable device to conduct an ATM transaction; and
a second communication port for enabling wireless communication between the ATM and a second portable device retained by a service person when the service person uses the second portable device to service the ATM.

2. An ATM according to claim 1, wherein the first communication port and the second communication port comprise the same communication port.

3. An ATM according to claim 1, wherein the second communication port is different from the first communication port and is accessible to only service personnel.

4. An ATM according to claim 3, wherein the first communication port is located outside the ATM, and the second communication port is located inside the ATM.

5. A method of operating an automated teller machine (ATM) when a service person uses a portable device retained by the service person to service the ATM, the method comprising:
establishing wireless communication between the ATM and the portable device; and
downloading diagnostic data to the portable device via the wireless communication established between the ATM and the portable device to allow the service person to service the ATM.

6. A method of operating an automated teller machine (ATM), the method comprising:
establishing a first wireless communication between the ATM and a first portable device retained by an ATM customer when the ATM customer uses the first portable device to conduct an ATM cash dispense transaction to obtain cash;
executing the ATM cash dispense transaction;
dispensing cash to the ATM customer when the ATM cash dispense transaction is executed;
preparing data relating to the ATM cash dispense transaction that has been executed;
transferring the prepared data to the first portable device via the first wireless communication to provide the ATM customer with an electronic receipt for the ATM cash dispense transaction;
receiving from the first portable device personal information which is unrelated to the ATM cash dispense transaction and which is associated with the ATM customer when the electronic receipt is provided to the ATM customer;
downloading to the first portable device specific information which is unrelated to the ATM cash dispense transaction and which is tailored to the ATM customer based upon the received personal information from the first portable device;
establishing a second wireless communication between the ATM and a second portable device retained by a service person when the service person uses the second portable device to service the ATM; and
downloading diagnostic data to the second portable device via the second wireless communication established between the ATM and the second portable device to allow the service person to service the ATM.

7. A method according to claim 6, wherein (i) the first wireless communication between the ATM and the first portable device retained by the ATM customer is established through a first wireless port of the ATM, and (ii) the second wireless communication between the ATM and the second portable device retained by the service person is established through a second wireless port of the ATM.

8. A method according to claim 7, wherein the first communication port and the second communication port comprise the same communication port.

9. A method according to claim 7, wherein the second communication port is different from the first communication port and is accessible to only service personnel.

10. A method according to claim 9, wherein the first communication port is located outside the ATM, and the second communication port is located inside the ATM.
